(19) United States
(12) Patent Application Publication
(10) Pub. No.: US 2009/0010636 A1
(43) Pub. Date: Jan. 8, 2009

(54) FINDER OPTICAL SYSTEM AND SINGLE-LENS REFLEX CAMERA HAVING SAME

(75) Inventors: Kazuhiro YAMADA, Saitama (JP); Hidenori TAKUSHIMA, Saitama (JP); Ken HIRUNUMA, Tokyo (JP); Takanobu SHIOKAWA, Kanagawa (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/167,403

(22) Filed: Jul. 3, 2008

(30) Foreign Application Priority Data
Jul. 5, 2007 (JP) 2007-177668

(51) Int. Cl. G03B 13/02

(52) U.S. Cl. 396/384

(57) ABSTRACT

The finder optical system has a reflex mirror, a focal plane plate, a prism, an eyepiece, and a dust-proofing multilayer. The reflex mirror is disposed on an optical path of a photographing optical system. The focal plane plate is disposed at a position on which an image is formed by a light which passes through the photographing optical system and which is reflected by the reflex mirror. The light-input surface of the prism races a light-output surface of the focal plane plate. The eyepiece faces a light-output surface of the prism. The dust-proofing multilayer, which is provided on a surface of the focal plane plate, has a water-repellent or water- and oil-repellent layer and an anti-static layer.

### BACKGROUND OF THE INVENTION

1. Field of the Invention

The present invention relates to a finder optical system having high dust-proofing ability, and a single-lens reflex camera having the finder optical system.

2. Description of the Related Art

Conventionally, a finder optical system in a single-lens reflex camera has a focal plane plate on which an object image is formed from light reflected by a reflex mirror, a pentaprism which converts the object image on the focal plane to an upright image, and an eyepiece which magnifies the upright image for observation. The finder optical system is usually sealed in a mirror box, in order to prevent an outside dust from entering and adhering to the components.

However, when the finder optical system is assembled, dust sometimes inadvertently sealed in the mirror box together with the finder optical system. Furthermore, the components are usually coated with some material. Such coating may be shed over time and becomes dust-like debris. Dust is undesirable because it may appear in the field of view and impair observation. In order to remove the dust from the field of view, typically it is necessary to disassemble the finder optical system and clean all the components. Therefore, dust removal operation is complicated and takes a long time.

Japanese Unexamined Patent Publication (KOKAI) No. H10-104692 (U.S. Pat. No. 6,266,490) discloses that an optical element such as a prism or a condenser lens, which is disposed near an imaging surface (namely, a focal plane plate), is formed by antistatic resin in order to provide dust proofing. However, it is impossible for the optical element of the anti-static resin to prevent electrically neutral fine dust from adhering thereto.

Japanese Unexamined Patent Publication No. 2001-13548 discloses that a pair of holes communicating via a space presented between a prism and a condenser lens is provided on a front surface of a mirror box in the finder optical system. In this finder optical system, air is blown into the space through a nozzle inserted into one of the holes, and the dust is blown off by the blown air and is ejected through the other hole.

However, in this finder optical system, when the dust is removed, it is necessary to detach and attach cover members sealing the holes, making dust removal complicated. In addition, an air compressor is required for blowing the air, thereby increasing the cost.

### SUMMARY OF THE INVENTION

Therefore, an object of the present invention is to provide a finder optical system having high dust-proofing ability, and a single-lens reflex camera having the finder optical system.

According to the present invention, there is provided a finder optical system which has a reflex mirror, a focal plane plate, a prism, an eyepiece, and a dust-proofing multilayer. The reflex mirror is disposed on an optical path of a photographing optical system. The focal plane plate is disposed at a position on which an image is formed by light which passes through the photographing optical system and which is reflected by the reflex mirror. The light-input surface of the prism faces the light-output surface of the focal plane plate. The eyepiece faces a light-output surface of the prism. The dust-proofing multilayer, which is provided on a surface of the focal plane plate, has a water-repellent or water- and oil-repellent layer and an anti-static layer.

### BRIEF DESCRIPTION OF THE DRAWINGS

The objects and advantages of the present invention will be better understood from the following description, with reference to the accompanying drawings in which:

FIG. 1A is a vertical sectional view, showing a first embodiment of a digital still camera having a finder optical system;

FIG. 1B is a vertical sectional view of the camera of FIG. 1A;

FIG. 1C is a horizontal sectional view of the camera of FIG. 1A;

FIG. 1D is a cross-sectional view showing a focal plane plate in the camera of FIG. 1A;

FIG. 2 is a cross-sectional view showing a second embodiment of a focal plane plate;

FIG. 3 is a cross-sectional view showing a third embodiment of a focal plane plate;

FIG. 4 is a cross-sectional view showing a fourth embodiment of a focal plane plate;

FIG. 5 is a cross-sectional view showing a fifth embodiment of a finder optical system;

FIG. 6A is an enlarged longitudinal sectional view Showing a focal plane plate in the camera of FIG. 1A;

FIG. 6B is an enlarged traverse sectional view showing a focal plane plate in the camera of FIG. 1A;

FIG. 7A is a schematic side view showing another embodiment of the focal plane plate;

FIG. 7B is a schematic plan view showing another embodiment of the focal plane plate; and

FIG. 8A is a vertical sectional view, showing the camera of FIG. 1A when the reflex mirror in flipped up; and

FIG. 8B is a vertical sectional view, showing the camera of FIG. 1A when the reflex mirror is flipped up.

### DESCRIPTION OF THE PREFERRED EMBODIMENTS

The present invention will be described below with reference to the embodiments shown in the drawings.

### [1] Finder Optical System and Single-Lens Reflex Camera

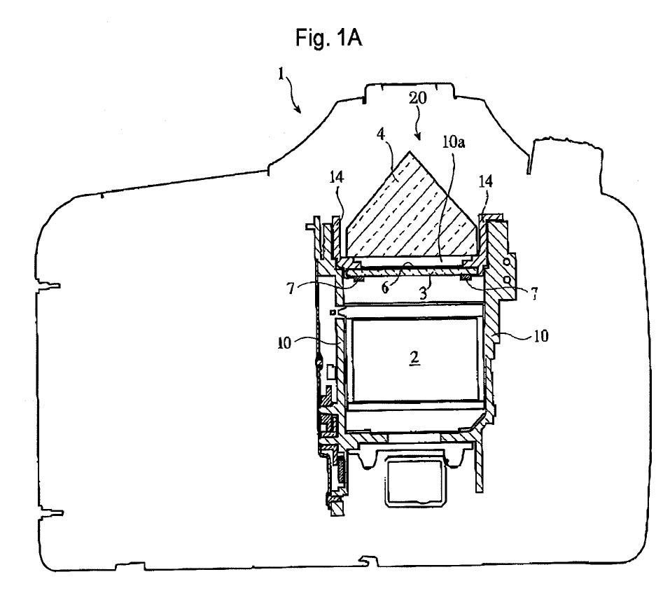

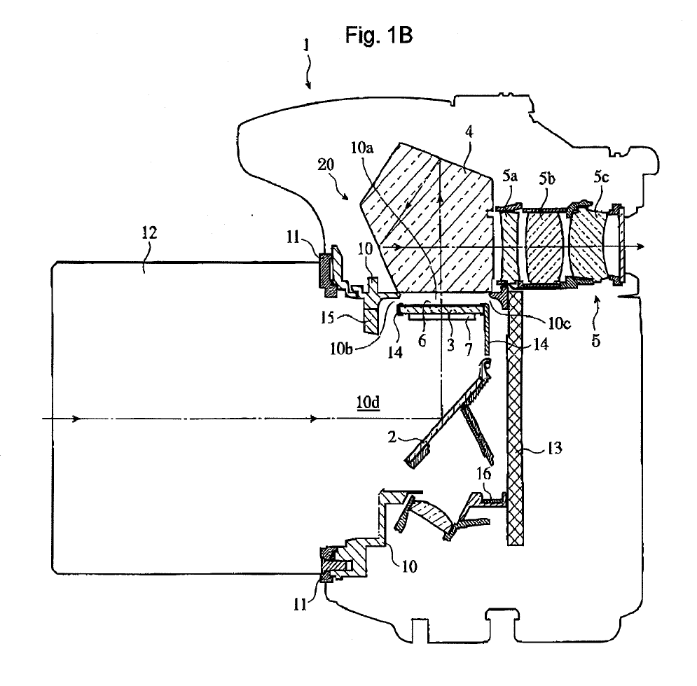

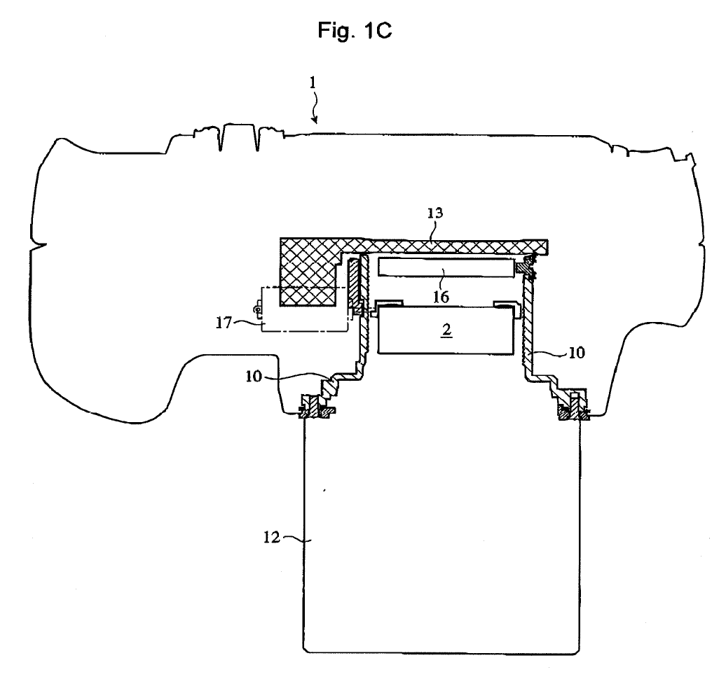

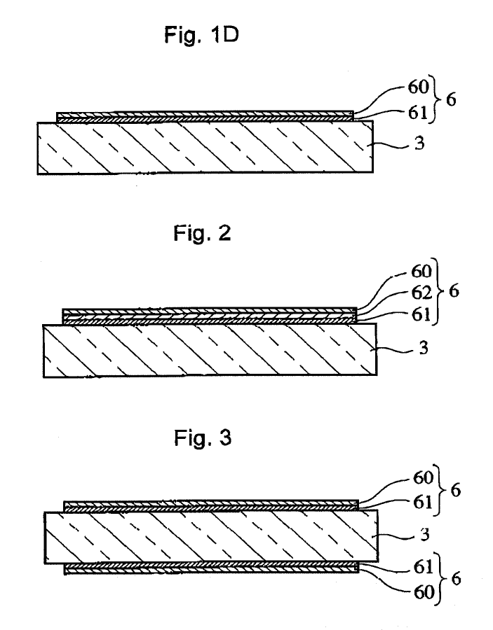

FIGS. 1A, 1B, and 1C show a first embodiment of a single-lens reflex camera having a finder optical system according to this invention.

The camera has a mirror box 10, a lens mount 11, an interchangeable lens 12 (the photographing optical system), a finder optical system 20, and a shutter 13. The mirror box 10 is a bases member which holds the finder optical oyster 20 and is fixed on a camera body 1. The lens mount 11 is fixed to an opening of the mirror box 10, and the interchangeable lens 12 is mounted on the camera body 1 through the lens mount 11.

The finder optical system 20 has a reflex mirror 2, a focal plane plate 3, a pentaprism 4, and an eyepiece 5 including lenses 5a, 5b, and 5c. The reflex mirror 2 and the focal plane plate 3 are disposed in the mirror box 10. The reflex mirror 2 is disposed in an optical path of the photographing optical system and is rotatably held by the mirror box 10.

The focal plane plate 3 is held by a holding frame 14, which is fixed to the mirror box 10. The focal plane plate 3 is disposed at the position on which the image is formed by the light which passes through the photographing optical system and which is reflected by the reflex mirror 2. The pentaprism 4 is disposed so that the light-input surface of the pentaprism 4 faces a light-output surface of the focal plane plate 3. The eyepiece 5 is disposed so as to face the light-output surface of the pentaprism 4. Furthermore, the image, which forms on the focal plane plate 3 (focal plane), is observed through the pentaprism 4 and the eyepiece 5, while the image is magnified by the eyepiece 5.

The shutter 13 is disposed at the optical path behind the reflex mirror 2. When photographing, the reflex mirror 2 is flipped up by rotation so as to leave the optical path, and the shutter 13 is opened. Due to these movements, an imaging device or a film (not shown in FIGS.) is exposed by the light passing through the photographing optical system.

FIG. 1D shows the focal plane plate in the first embodiment. The focal plane plate 3 has a dust-proofing multilayer 6 which is formed on the light-output surface of the focal plane plates 3. The dust-proofing multilayer 6 has a water-repellent or water- and oil-repellent layer (Hereinafter, it is referred to as “water-oil repellent layer”) 60 and an anti-static layer 61 which are disposed in this order from the light output side (from the outside of the multilayer 6).

FIG. 2 shows a focal plane plate in a second embodiment. The focal plane plate 3 in the second embodiment has a same structure as that in the first embodiment, except that the dust-proofing multilayer 6 has the water-oil repellent layer 60, a fine roughness layer 62, and the anti-static layer 61, which are disposed in this order from the light output side. Further, fine roughness is formed at an outer surface of the fine roughness layer 62, as described below in detail.

FIG. 3 shows a focal plane plate in a third embodiment. The focal plane plate 3 in the third embodiment has a same structure as that in the first embodiment, except that the dust proofing multilayer 6 having the water-oil repellent layer 60 and the anti-static layer 61 which are disposed in this order from the outside of the multilayer 6 is provided on both surfaces (namely, light-input and light-output surface) of the focal plane plate 3.

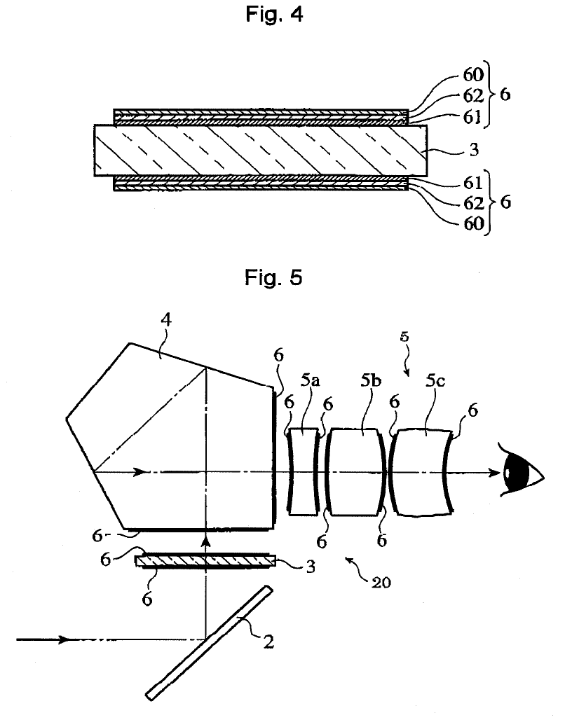

FIG. 4 shows a focal plane plate in a fourth embodiment. The focal plane plate 3 in the fourth embodiment has a same structure as that in the first embodiment, except that the dust-proofing multilayer 6 having the water-oil repellent layer 60, the fine roughness layer 62, and the anti-static layer 61 which are disposed in this order from the outside of the multilayer 6 is provided on both surfaces (namely, light-input and light-output surfaces) of the focal plane plate 3.

The dust-proofing multilayer 6 may be provided not only on the surface of the focal plane plate 3 but also on one or more of the surfaces of: the pentaprism 5 and lenses 5a, 5b, and 5c. FIG. 5 shows a fifth embodiment of the digital still camera according to this invention. In this embodiment, the dust-proofing multilayer 6 is provided on all of light-input and light-output surfaces of the pentaprism 4 and the lenses 5a, 5b, and 5c.

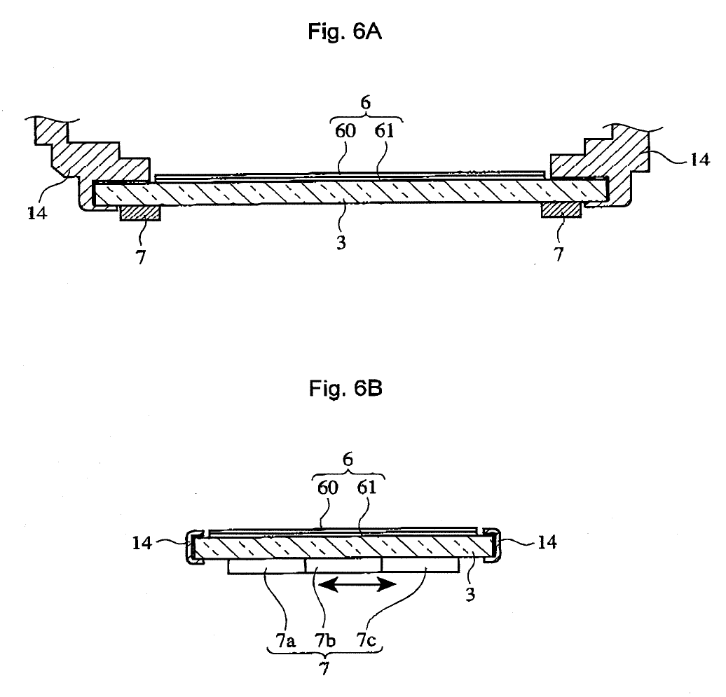

As shown in FIGS. 1A and 1B, the focal plane plate 3 is preferably provided with piezoelectric elements 7 and 7, but this invention is not limited to this structure. The piezoelectric elements 7 are used for removing the dust adhering to the surface (light-input and light-output surfaces) of the focal plane plate 3. The piezoelectric elements 7 are mounted on both ends in a longitudinal direction of the plate 3, respectively. As shown in FIGS. 6A and 6B in detail, three piezoelectric elements 7a, 7b, and 7c which extend in a width direction of the plate 3 are mounted in series on each end as the piezoelectric element 7.

Both the piezoelectric elements 7 are expanded and contracted in phase by applying periodic voltage to the piezoelectric elements 7 by an oscillator (not shown in FIGS.), and as a result the focal plane plate 3 is vibrated in the width direction. Due to this vibration, the dust which adheres to the focal plane plate 3 can be flicked off. The frequency and magnitude of the applied voltage may be adjusted to preference.

The circuit for driving the piezoelectric elements 7 is not limited, but may be the circuit disclosed in Japanese Unexamined Patent Publication No. 2002-204379 (U.S. Pub. No. 2004-0012714) or No. 2003-319222 (U.S. Pub. Nos. 2003-0202114 and 2007-0296819). Furthermore, it is preferable that the focal plane plate 3 be electrically connected to the camera body 1 through a ground wire for anti-static protection, when the focal plane plate 3 is provided with piezoelectric elements 7. Due to the ground wire, the electric charge on the focal plane plate 3 is always prevented, which can increase the dust-proofing ability of the focal plane plate 3.

The finder optical system may have a dust-proofing mechanism which mechanically removes dust besides the piezoelectric element. Such dust-proofing mechanism may be a roller or a wiper, which can wipe a surface of the focal plane plate 3 off, for example.

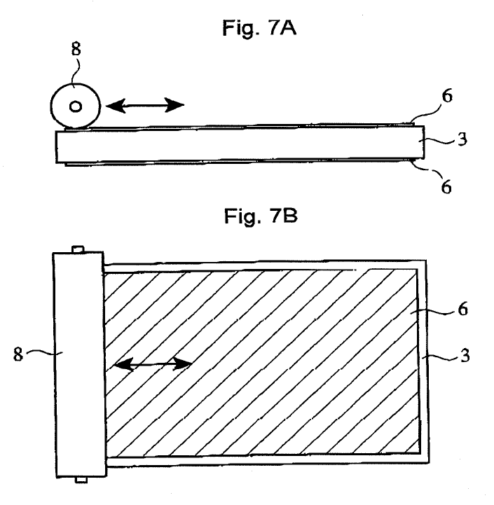

FIGS. 7A and 7B show another embodiment of the dust-proofing mechanism. A camera comprising the dust-proofing mechanism shown in FIGS. 7A and 7B has the same structure as that in the camera in FIG. 1, except that the camera has a roller which is rolled on the light-output surface of the focal plane plate 3 (namely, the outermost surface of the dust-proofing multilayer 6). The material constituting the roller 8 may be rubber, or the like. The dust adhering to the light-output surface is removed by the roller 8 which is rolled on the light-output surface while contacting the light-output surface. The roller 8 is rotated by a motor (not shown in FIGS.), and the rotated roller 8 together with the motor is linearly moved by a linear drive mechanism such as a linear actuator, a linear motor, or the like. The operating sequence and the circuit for driving the roller 8 are not limited.

Instead of the roller 8, a wiper, which is moved across the light-output surface of the focal plane plate 3 while contacting the light-output surface, may be utilized. The material constituting the wiper may be rubber, non-woven fabric, woven fabric, or the like.

As shown in FIGS. 1A and 1B, it is preferable that, in the upper space in the mirror box 10, a narrow space 10a be presented between the focal plane plate 3 and the pentaprism 4, and that the narrow space 10a have openings 10b, and 10c, which are formed on the front side (interchangeable lens 12 side) and rear side (shutter 13 side) of the space 10a, respectively. In this structure, the dust adhering to the light-output surface of the focal plane plate 3 and the light-input surface of the pentaprism 4 can be blown off and removed, when the mirror 2 is flipped up, as described below.

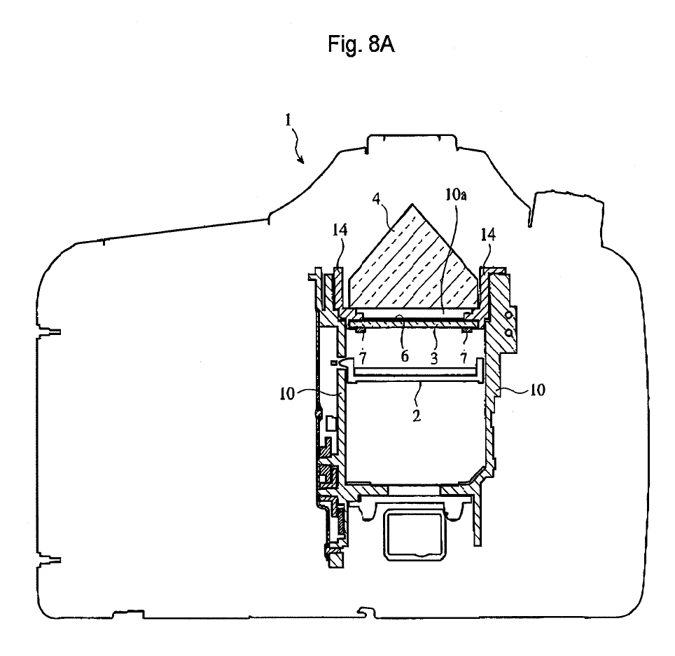

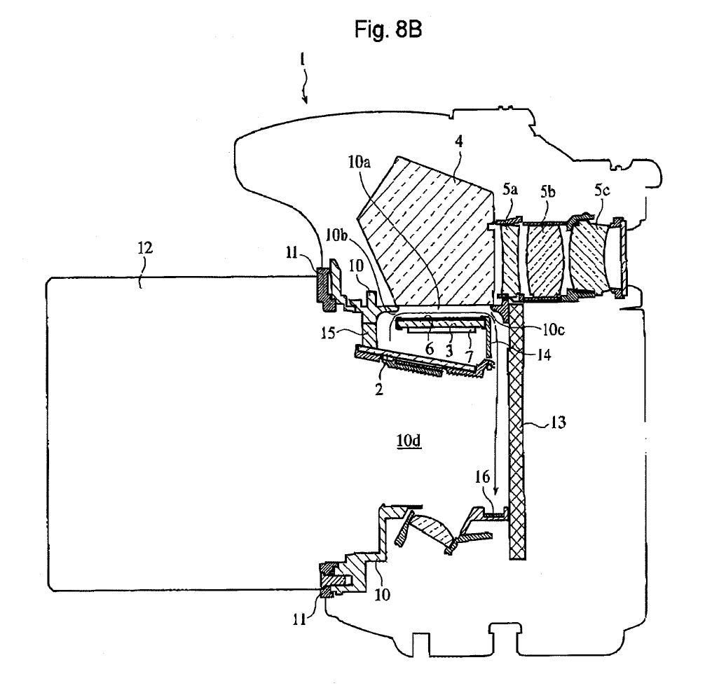

As shown in FIGS. 8A and 8B, while the shutter 13 is closed, the mirror 2 is flipped up by rotating. When flipped up the mirror 2 contacts a cushioning medium 15 and then stops at the position close to the focal plane plate 3. In this position, the mirror 2 substantially faces the focal plane plate 3. The space 10a between the focal plane plate 3 and the pentaprism 4 is communicate with the Space 10d in which the mirror 2 is disposed, through the openings 10b and 10c. Furthermore, the length of the mirror 2 in the longitudinal direction (namely, in the transverse direction in FIG. 1A) is substantially the same as that of focal plane plate 3 in the transverse direction in FIG. 1A. Therefore, an airflow, which is caused by flipping up the mirror passes the space 10a through the openings 10b and 10c. Due to this airflow, the dust adhering to the light-output surface of the focal plane plate 3 and the light-input surface of the pentaprism 4 can be blown off and removed. Thus, since the spaces 10a and lad are disposed in the mirror box 10, the airflow is generated in the mirror box 10.

It is preferable that an adhesive material 16 be provided in the mirror box 10. The adhesive material 16 is located near the shutter 13 on the bottom of the mirror box 10. The dust which is removed by the mirror 2 drops along the front surface or the shutter 13 and then adheres to the adhesive material 16. Therefore, the removed dust does not float in the mirror box 10. The adhesive material 16 may comprise acryl ester polymer or a different material.

Normally, the airflow wind speed required in order to remove dusts from the space in a clean room, a clean booth, or a clean bench, is greater than or equal to 20 m/second, which is typhoon level. However, in this embodiment, a dust-proofing multilayer 6 is provided on the light-output surface of the focal plane plate 3, which reduces the adhesive force between dust and the focal plane plate 3 (for example, the liquid bridge force F₁, electrostatic attractive force F₂, electric image force F₅, and contact-charging adhesion force F₄, described below) and the intermolecular force of a dust particle adhering to the focal plane plate 3. Therefore, the dust adhering to the focal plane plate 3 can be blown off and removed by the airflow at a fraction of the required wind speed mentioned above.

Specifically, the wind speed of the airflow passing the space 10a is not limited, but may be about between 2 to 7 m/second. The wind speed can be adjusted by changing the rotational speed of the mirror 2 and the distance between the plate 3 and the prism 4.

A mechanism for flipping up and returning the mirror 2 when photographing can also be utilized for removing the dust. The mechanism may be a known mechanism, and may include a motor 17, a spring, a lever, a cam, etc.

The sequence for driving the dust-removal mechanism is not limited. For example, the number up and down movements may be appropriately determined. Furthermore, in order to remove the dust more efficiently, the focal plane plate 3 can be vibrated by the piezoelectric elements 7 simultaneously with the airflow generation by the mirror 2. In this case, the wind speed can be even lower than the above-mentioned speed because of the contribution of the vibration. Furthermore, it is preferable that the rotational speed of the mirror 2 on return be lower than when it is flipped up, to prevent dust from being raised again.

In order to drive the mirror 2 alone or together with piezoelectric elements 7 for dust-removal, the camera may have a drive circuit which drives one or both simultaneously, as well as circuits which are generally used in a conventional camera, such as a power supply circuit, a CPU for controlling the whole of the camera, an image signal-processing circuit, a display circuit, etc., but the drive circuit is not limited to a specific circuit. For example, a dust-removal switch may be provided on the camera, and when the switch is activated, the mirror 2 and piezoelectric elements 7 are driven simultaneously by the drive circuit. The sequence may also be activated when the camera is powered on.

### [2] Finder Optical System

The material constituting the mirror 2, the focal plane plate 3, the pentaprism 4, and the eyepiece lenses 5a, 5b, and 5c as well as their shape, may be ones that are known. For example, known optical glass or plastic can be utilized. The light-input surface of the focal plane plate 3 is a Fresnel Surface. The light-output surface of the focal plane plate 3, which is composed of a microprisms, is a matte surface having micron-size roughness. Furthermore, the light-output surface of plate 3 is a focal plane.

### [3] Dust-Proofing Multilayer

Hereinafter, the focal plane plate 3, the pentaprism 4, and the eyepiece lenses 5a, 5b, and 5c are termed “optical elements”. The dust-proofing multilayer 6 has at least the water-oil repellent layer 60 and the anti-static layer 61 which are disposed in this order from the outside of the multilayer 6. The duet-proofing multilayer 6 may have the fine roughness layer 62 which is disposed between the water-oil repellent layer 60 and the anti-static layer 61, or underlying the anti-static layer 61.

### (1) Water-oil Repellent Layer

The water-oil repellent layer 60 is formed at the outermost surface of the dust-proofing multilayer 6.

A liquid bridge force, hereinafter referred to au F₁, between a spherical dust particle and the optical element is represented by the following formula, and is the force of a liquid bridge generated by condensing the liquid at a contact point between the optical element and the dust particle.

F₁=−2πγD (1)

In Formula 1, γ is surface tension of the liquid, and D is a dust particle diameter. Consequently, the amount of water or oil adhering to the optical element is decreased by the water-oil repellent layer, which can reduce the adhesion of the dust particle to the optical element caused by the F₁.

Generally, the relationship between contact angle of water at a rough surface and that at a flat surface is approximated by the following formula.

cos θ_{γ}=γ cos θ (2)

In Formula 2, θγ is the contact angle at a rough surface, γ is the surface area multiplication factor, and θ is the contact angle at a flat surface. The surface area multiplication factor is generally greater than one. Consequently, if the θ is less than 90 degrees, the θ_{γ} is less than the θ. On the other hand, if the θ is more than 90 degrees, the θ_{γ} is more than the θ.

The hydrophilicity of a hydrophilic surface increases when the area of the hydrophilic surface is expanded by making the surface rough. Conversely, the water-repellency of a water-repellent surface increases when the area of the water-repellent surface is increased by making the surface rough. Accordingly, the high water-repellency is obtained by forming a water-repellent layer 60 on the fine roughness layer 62 having a fine roughness so that the roughness is maintained.

The material of the water-oil repellent layer 60 is not limited to a specified material, and any colorless and highly transparent material can be utilized. An inorganic compound including fluorine, an organic compound including fluorine, an organic and inorganic hybrid polymer including fluorine, a fluorinated pitch such as CFₙ, (n being 1.1 to 1.6), graphite fluoride, etc., are examples of such material.

At least one compound which is selected from the group consisting of LiF, MgF₂, CaF₂, AlF₃, BaF₂, YF₃, LaF₃, and CaF₃ may be used as the inorganic compound including fluorine. These compounds are available from Canon Optron Inc, for example.

A copolymer of an unsaturated ester monomer including fluoroaliphatic group and an unsaturated silane monomer, and an organic silicone polymer including fluorocarbon group may be used as the organic and inorganic hybrid polymer including fluorine.

As the copolymer of an unsaturated ester monomer including fluoroaliphatic group and an unsaturated silane monomer, the copolymer of the unsaturated ester monomer including fluoroaliphatic group represented by the following chemical formula 3 disclosed in Japanese Unexamined Patent Publication No. 2002-146271 (U.S. Pub. No. 2004-0028914) and an unsaturated silane monomer represented by the following chemical formula 4 is preferably utilized.

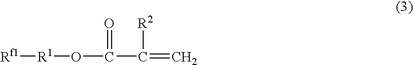

In the chemical Formula 3, R^{f1} is an aliphatic group which is at least partially fluorinated, R¹ is an alkylene group which may have another atomic group, and R² is hydrogen or a low alkyl group.

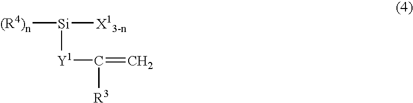

In chemical Formula 4, R³ and R⁴ are independently hydrogen or a low alkyl group, X¹ is an alkoxy group, a halogen group, or —OC(═O)R⁵ group, R⁵ being hydrogen or a low alkyl group, Y¹ is a single bond or —CH₂— group, and n is an integer ranging from 0 to 2.

A polymer which is obtained by hydrolyzing a silane compound including a fluorocarbon group exemplifies the organic silicone polymer including fluorocarbon group. The compound represented by the following chemical formula is exemplified as the silane compound having a fluorocarbon group.

CF₃(CF₂)ₐ(CH₂)₂SiR_{b}X_{c} (5)

In chemical Formula 5, R is an alkyl group, X is an alkoxy group or halogen atom, a is an integer ranging from 0 to 7, b is an integer ranging from 0 to 2, c is an integer ranging from 1 to 3, and (b+c) is equal to 3.

Compounds represented by Formula 5 are CF₃(CH₂)₂Si(OCH₃)₃, CF₃(CH₂)₂SiCl₃, CF₃(CF₂)₅(CH₂)₂Si(OCH₃)₃, CF₃(CF₂)₅(CH₂)₂SiCl₃, CF₃(CF₂)₇(CH₂)₂Si(OCH₃)₃, CF₃(CF₂)₇(CH₂)₂SiCl₅, CF₃(CF₂)₇(CH₂)₂SiCH₃(OCH₃)₂, CF₃(CF₂)₇(CH₂)₂SiCH₃Cl₂, etc. As the organic silicone polymer, the commercially available compound can be utilized, such as XC-98-B2472 manufactured by GE Toshiba Silicone Co., Ltd.

An example of the organic compound including fluorine is fluorocarbon polymer. Example of the fluorocarbon polymer include a polymer of olefin compound including fluorine, and a copolymer of olefin compound including fluorine and a monomer which can be copolymerized therewith. Examples of such polymer and copolymer include polytetrafluoroethylene, tetraethylene-hexafluoropropylene copolymer, ethylene-tetrafluoroethylene copolymer, tetrafluoroethylene-perfluoroalkylvinylether copolymer, ethylene-chlorotrifluoroethylene copolymer, tetrafluoroethylene-hexafluoropropylene-perfluoroalkylvinylether copolymer, polychlorotrifluoroethylene, polyvinilydenefluoride, and polyvinylfluoride.

A compound obtained by polymerizing a commercially available compound including fluorine may be utilized as the fluorocarbon polymer. OPSTAR manufactured by JSR Corporation and CYTOP manufactured by ASAHI GLASS Co., Ltd. are examples of the compound including fluorine.

The thickness of the water-oil repellent layer 60 is preferably 0.4 to 100 nm. The thickness is more preferably 10 to 80 nm. If the thickness is less than 0.4 nm, the water-oil repellent ability will be insufficient.

### (2) Anti-Static Layer

The anti-static layer 61 is provided underlying the water-oil repellent layer 60. The anti-static layer lowers Coulomb's force which causes dust to adhere to the optical element. Consequently, the dust-proofing ability is improved.

An electrostatic attractive force between a spherical dust particle which is uniformly electrically charged and the optical element, hereinafter referred to as F₂, is represented by the following formula.

$${F}_{2} = - \frac{1}{4 π {ɛ}_{0}} \cdot \frac{{q}_{1} {q}_{2}}{{r}^{2}} \qquad ( 6 )$$

In Formula 6, q₁ and q₂ are electric charges of the water-oil repellent layer 60 and the dust particle, respectively, r is a radius of the dust particle, and ε₀ is a permittivity of free space, equal to 8.85×10⁻¹² (F/m). It is obvious from the above formula 9 that F₂ can be lowered by decreasing the electric charges of the water-oil repellent layer 60 and the dust particle. Consequently, it is effective to remove the charge using the anti-static layer 61.

An electric image force between a spherical dust particle which is uniformly electrically charged and the water-oil repellent layer 60, hereinafter referred to as F₃, is represented by the following formula. Furthermore, when the electrically charged dust particle approaches the water-oil repellent layer 60 which is not originally electrically charged, a charge opposite in sign but of the same magnitude no that of the dust particle is induced an the water-oil repellent layer 60. This inducing causes the

$${F}_{3} = - \frac{1}{4 π {ɛ}_{0}} \frac{( ɛ - {ɛ}_{0} )}{( ɛ + {ɛ}_{0} )} \cdot \frac{{q}^{2}}{{( 2 r )}^{2}} \qquad ( 7 )$$

In formula 7, ε₀ is the permittivity of free space, equal to 8.85×10⁻¹² (F/m), ε is the permittivity of the water-oil repellent layer 60, q is an electrical charge of the dust particle, and r in the radius of the dust particle. F₃ substantially depends on degree of the electrical charge on the dust particle. Consequently, the F₃ can be lowered by removing the electrical charge in the dust particle adhering to the water-oil repellent layer 60 using the anti-static layer.

It is preferable that the surface resistivity of the anti-static layer 61 be less than or equal to 1×10¹⁴ Ω/square. It is even more preferable that the surface resistivity be less than or equal to 1×10¹² Ω/Square. The thickness of the anti-static layer 61 is not limited, but it is preferably 0.01 to 3 μm when the anti-static layer 61 is disposed at the innermost position of the dust-proofing multilayer 6. Furthermore, it is preferably 0.4 to 100 nm, and more preferably 10 to 80 nm, when the anti-static layer 61 is disposed between the water-oil repellent layer 60 and the fine roughness layer 62.

The material of the anti-static layer 61 is not limited to a specified material, and any colorless and highly transparent material can be utilized. The anti-static layer 61 is formed of at least one conductive inorganic compound which is selected from the group consisting of antimony oxide, indium oxide, tin oxide, zinc oxide, ITO (tin doped indium oxide), and ATO (antimony doped tin oxide).

The anti-static layer 61 may be a composite layer which consists essentially of a fine particle (conductive inorganic fine particle) of the conductive inorganic compound mentioned above, and binder, or may be a dense layer (for example, a deposited layer) consisting essentially of the conductive inorganic compound. The binder component is a monomer or an oligomer whose polymer is the binder. Examples of the binder component include metal alkoxide, oligomer of the metal alkoxide, and ultraviolet curing or thermosetting compound such as acrylic ester.

### (3) Fine Roughness Layer

The fine roughness layer 62 is provided between water-oil repellent layer 60 and the anti-static layer 61 or underlying the antistatic layer 61. At the outer surface of the fine roughness layer 62, fine roughness is formed. When the dust-proofing multilayer 6 has the fine roughness layer 62, the dust-proofing ability of the dust-proofing multilayer 6 improves due to the decrease in intermolecular force of dust particles adhering to the optical element and the contact-charging adhesion force F₄ described below. Hereinafter, the dust-proofing multilayer 6 having the fine roughness layer 62 is called “rough dust-proofing multilayer 6”.

An intermolecular force of a dust particle adhering to the rough dust-proofing multilayer 6 diminishes as a three-dimensional average surface roughness of the dust-proofing multilayer 6 increases. Furthermore, the three-dimensional average surface roughness is an index of surface density of the fine roughness, and is hereinafter referred to as SRa. In addition, the contact-charging adhesion force (hereinafter referred to as F₄) between a spherical dust particle which is uniformly electrically charged and the rough dust-proofing multilayer 6 is represented by the following formula, and generated by the difference in the chemical potentials.

$${F}_{4} = - \frac{{πɛ}_{0} {V}_{c}^{2} {A}^{2} {k}^{2} {D}^{2}}{457 {( {z}_{0} + b )}^{8}} \qquad ( 8 )$$

In the above formula, the ε0 is a permittivity of free space, equal to 8.85×10¹² (F/m); V_{c} is the contact potential difference between the rough duet-proofing multilayer 6 and a dust particle; A is the Hamaker constant equivalent to van der waals interaction; k is a coefficient equal to the sum of k1(=(1−ν₁²)/E₁) and k2 (=(1−ν₂²)/E₂), ν₁ and ν₂ are Poisson ratios of the rough dust-proofing multilayer 6 and a dust particle, respectively; E₁ and E₂ are Young's moduls of the rough dust-proofing multilayer 6 and a dust particle, respectively; D is a dust particle diameter, zₒ is the distance between the rough dust-proofing layer 6 and the dust particle; and b is the SRa of rough dust-proofing multilayer 6. It is clear from Formula 8 that F₄ diminishes as the SRa of the rough dust-proofing multilayer 6 becomes larger.

Concretely, when the SRa of the rough dust-proofing multilayer 6 is greater than or equal to 1 nm, the intermolecular force of the dust particles which adheres to the rough dust-proofing multilayer 6 and the F1 are sufficiently low. However, if the SRa of the rough dust-proofing multilayer 6 is more than 100 nm, incident light disperses on the rough dust-proofing multilayer 6. Light dispersion is unsuitable for the optical element. Consequently, it is preferable that the SRa of the rough dust-proofing multilayer 6 be from 1 to 100 nm. More preferably, the SRa of the multilayer 6 is 8 to 80 nm. Most preferably, the SRa of the multilayer 6 is 10 to 50 nm. The SRa in an index calculated by taking the center-line-average roughness which is defined by JIS B0601 with using an atomic force microscope, in three dimensions. The SRa is represented by the following formula.

$$SRa = \frac{1}{{S}_{0}} {\int }_{{Y}_{B}}^{{Y}_{T}} {\int }_{{X}_{L}}^{{X}_{R}} \vert F ( X , Y ) - {Z}_{0} \vert d X d Y \qquad ( 9 )$$

In Formula 9, X and Y are X and Y dimensions; X_{L} and X_{R} are both ends of a surface to be measured in the X dimension; Y_{B} and Y_{T} are both ends of the surface to be measured in the Y dimension; the S₀ is the area of the surface to be measured assuming it were flat, calculated as |X_{R}−X_{L}|×|Y_{T}−Y_{B}|; F(X, Y) is the height at each measured point (X, Y); and Zₒ is the average height of the surface to be measured.

The Hamaker constant A in the Formula 8 is approximated by a function of a refractive index, and the constant A gets smaller as the refractive index becomes smaller. The refractive index of the water-oil repellent layer 60, the fine roughness layer 62, and the anti-static layer 61 is preferably less than or equal to 1.50, and is more preferably less than or equal to 1.45. The maximum peak-to-valley value (hereinafter referred to as P-V) of the rough dust-proofing multilayer 6 is not limited but is preferably 5 to 1,000 nm. Furthermore, the maximum peak-to-valley value means the height difference between the highest peak and the lowest valley. More preferably, the P-V of the multilayer 6 is 50 to 500 nm, and most preferably it is 100 to 300 nm. When the P-V is 5 to 1,000 nm, the rough dust-proofing multilayer 6 possesses an especially high anti-glare property. In addition, when the P-V is 50 to 500 nm, the rough dust-proofing multilayer 6 will have also high transmissibility. P-V can be measured with an atomic force microscope.

The specific surface area of the rough dust-proofing multilayer 6 is not limited, but it is preferable that a specific surface area (hereinafter referred to as S_{R}) of the rough dust-proofing multilayer 6 be greater than or equal to 1.05. It is more preferable that the S_{R} of the multilayer 6 be greater than or equal to 1.15. However, it is preferable that the S_{R} of the multilayer 6 not be so large that light can not be dispersed on the surface. The S_{R} is calculated by the formula

S_{R}=S/S₀ (10)

In Formula 10, the S₀ is the area of the surface to be measured assuming that the surface to be flat, and S is calculated by the following method. The surface to be measured is divided into a multiple fine triangles having three vertices. Vector product |a×b|, a being the vector from a first vertex to a second vertex and the b being a vector from a first vertex to a third vertex, is calculated as the area of each fine triangles. The S is calculated by summing areas of all the fine triangles.

The fine roughness is produced at the surface of the fine roughness layer 62 by the method described below so that the SRa, P-V, and S_{R} of the fine toughness layer 62 are in the range described above. And then, the water-oil repellent layer 60 (and the anti-static layer 61) is produced on the surface of the fine roughness layer 62 so that the roughness is maintained. Due to this, the SRa, P-V, and S_{R} of the outermost of the dust-proofing multilayer 6 can be in the range described above.

Specifically, when the fine roughness layer 62 is provided between the water-oil repellant layer 60 and the anti-static layer 61, the thickness of the water-oil repellent layer 60 is 0.4 to 100 nm, and preferably is 10 to 80 nm. When the fine roughness layer 62 is provided underlying the anti-static layer 61, the thickness of the water-oil repellent layer 60 and the thickness of the anti-static layer 61 are 0.4 to 100 nm, and preferably 10 to 80 nm. The thickness of the fine roughness layer 62 is not limited to a specific range, but is preferably 0.05 to 3 μm. The thickness includes the fine roughness of the surface.

The fine roughness layer 62 may be formed by treating a gel layer including alumina or a deposited layer consisting essentially of aluminum, alumina or a mixture of these, with hot water; or it may be formed by treating a gel layer including zinc compound with water having a temperature greater than or equal to 20 degrees Celsius, for example.

The former comprises a roughness which is composed of irregularly distributing a plurality of convexities, each having an irregular fine shape, and a plurality of groove-shaped concavities between them. The convexities are produced when the hot water acts on the superficial layer of the gel or deposited layer. This layer in called a “fine roughness alumina layer” unless otherwise noted.

The latter comprises a roughness which is composed of irregularly distributing a plurality of convexities and a plurality of concavities located between them. The convexity is formed of a precipitate which is produced when water at a temperature greater than or equal to 20 degrees Celsius acts on the superficial layer of the gel layer including zinc compound. The shape of the convexity varies according to the kind of the zinc compound, but is quite fine. This layer is called to “fine roughness zinc compound layer” unless otherwise noted.

The main component of the fine roughness alumina layer is preferably alumina, aluminum hydroxide, or a mixture of these. It is more preferable that the fine roughness alumina layer consists of alumina, but it may include at least one optional component which is selected from the group consisting of zirconia, silica, titania, zinc oxide, and zinc hydroxide, if desired. The quantity of the optional component(s) is not limited so long as the fine roughness can be produced by treating the gel layer or the deposited layer with hot water and the transparency of the dust-proofing layer is not lost. However, this quantity preferably ranges from 0.01 to 50 mass percents, and more preferably 0.05 to 30 mass percents with respect to 100 mass percents for the whole of the fine roughness layer 62.

The main component of the fine roughness zinc compound layer is preferably zinc oxide, and/or zinc hydroxide. It is more preferable that the fine roughness alumina layer consists of the one described above, but it may include at least one optional component which is selected from the group consisting of alumina, zirconia, silica, and, titania, if desired. The quantity of the optional components) is not limited if the fine roughness can be produced by treating the gel layer including the zinc compound with water having a temperature greater than or equal to 20 degrees Celsius and the transparency of the dust-proofing multilayer 6 is not lost. However, preferably it ranges 0.01 to 50 mass percents, and more preferably 0.05 to 30 mass percents with respect to 100 mass percents for the whole fine roughness layer 62.

The fine roughness layer 62 may be formed by patterning a layer consisting essentially of a transparent metal oxide such as alumina, zinc oxide, zirconia, silica, titania, etc. by a photolithographic method.

The roughness of the fine roughness layer 62 can be detected by observing the superficial layer or the cross-section using a scanning electron microscope, or by observing the superficial layer using an atomic force microscope (especially, by observing the superficial layer obliquely).

### [4] Producing Dust-Proofing Multilayer

### (1) Water-Oil Repellent Layer

### (a) Method for Producing Layer of Inorganic Compound Including Fluorine

A layer consisting essentially of an inorganic compound including fluorine can be formed by physical vapor deposition, such as vacuum deposition, sputtering, or ion-plating, etc., or chemical vapor deposition (CVD), such as thermal CVD, plasma CVD, or optical CVD, etc. Vacuum deposition method is preferable from an economical standpoint.

In the vacuum deposition method, the deposited layer is formed by condensing vapor of the deposition material, in this case inorganic compound including fluorine, on the optical element under high vacuum, such as about 1×10⁻⁴ to 1×10⁻² Pa.

The method for vaporizing the deposition material is not limited to a specified method. Any methods for vaporizing, such as vaporization by an electric heating source, vaporization by an electron beam radiated from an E-type electron gun, vaporization by a large current electron beam generated by hollow cathode discharge, a laser ablation method, (this is, vaporization by laser pulse), can be utilized. It is preferable that the optical element be rotated during the deposition process, held so that the surface to be treated faces the deposition material. The thickness of the deposited layer can be controlled by adjusting the deposition time.

### (b) Method for Producing Layer of Copolymer of Unsaturated Ester Monomer Including Fluoroaliphatic Group and Unsaturated Silane Monomer

A layer of the copolymer of the unsaturated ester monomer including fluoroaliphatic group and an unsaturated silane monomer may be formed using to a method of coating copolymer or a method of polymerization. In the method of coating copolymer, at least both monomers are copolymerized, a solution including the synthesized copolymer is applied to the optical element, and the applied solution is dried. In the method of polymerization, a solution including both monomers or oligomers of these is applied on the optical element, the applied solution is dried, and after that they are polymerized.

### (i) Case of Method of Coating Copolymer

The copolymer of the unsaturated ester monomer including fluoroaliphatic group and an unsaturated silane monomer is produced by a known method of radical polymerization. For example, the copolymer can be obtained by dissolving at least both monomers in an adequate solvent and adding a radical polymerization initiator such as azobisisobutyronitrile to the solvent, and then heating the solvent with the monomers and the initiator at 60 to 75 degrees Celsius for 10 to 20 hours. Examples of the solvent include hydrofluoroether, such as C₃F₇OCH₃, C₃F₇OC₂H₅, C₄F₉OCH₃, and C₄F₉OC₂Hs, and hydrofluorocarbon, such as CF₃CFHCFHCF₂CF₃ and C₅F₁₁H.

A copolymer-solution is prepared by dissolving or dispersing the copolymer which is obtained as described above in the solvent. A highly volatile solvent may be used as the solvent. Examples of the highly volatile solvent include hydrofluoroether and hydrofluorocarbon described above; perfluoroether such as C₄F₉OCFₐ, C₄F₉OC₂F₅, etc.; linear fluorocarbon such as ethane trifluoride, C₆F₁₄, and C₇F₁₆, etc.; saturated hydrocarbon such as pentane, hexane, heptane, etc.; ethers such as tetrahydrofuran, diethyl ether, dioxane, etc.; ketones such as acetone, methyl ethyl ketone, methyl i-butyl ketone, cyclohexane, etc.; and esthers such as ethyl acetate, butyl acetate, etc. Especially, hydrofluoroether and perfluoroether are preferable.

The concentration of the copolymer-solution is preferably 0.1 to 150 g/L, and is more preferably 1 to 50 g/L. The copolymer-solution which is commercially available may be utilized, for example, Novec EGC-1700 and Novea EGC-1720 manufactured by Sumitomo 3M Ltd.

As the method of applying the application liquid, any common coating method, such as a dip coating method, a spin coating method, a spray method, a flow coating method, a roll coating method, a reverse coating method, a flexo printing method, a screen printing method, or a combination of two or more of those can be utilized. Among these, the dip coating method is preferable because it makes it easy to produce the uniform layer and to control the thickness of the layer.

The solvent is removed by drying after applying the copolymer-solution. Common drying methods such as air drying method, heated air drying method, and oven dry method, may be utilized for drying. A vacuum drying method can be utilized if desired. In the air drying method, for example, low humidity gas may be forcibly blown over the copolymer-solution.

### (ii) Case of Method of Polymerization

It is preferable to carry out a radiation polymerization after applying monomer/oligomer solution to the optical element. In the radiation polymerization, UV light, X ray, or an electron beam are preferable utilized as the radial rays. The method of polymerization using the ultraviolet ray is explained below. The monomer/oligomer solution is prepared by dissolving or dispersing both the monomers or oligomers of these and a radical polymerization initiator in the solvent. The radical polymerization initiator and solvent may be the same those as mentioned above. The concentration of the monomer/oligomer solution is preferably 0.1 to 150 g/L, and more preferably 1 to 50 g/L.

The monomer/oligomer solution may include a stabilizer such as acetonitrile, ureas, sulfoxide, amides, etc., a polymerization inhibitor such as hydroquinone monomethyl ether, and so on, in addition to the components described above.

Any common coating method, mentioned above, may be utilized for applying the monomer/oligomer solution on the optical element. The solvent is removed by drying after applying the copolymer-solution. The monomer/oligomer solution may be dried in a manner similar to that described above. The monomers or oligomers on the optical element are polymerized by UV light. The intensity of the irradiated UV light may be adjusted according to a kind of monomer, thickness of the layer, and other factors but may be about 500 to 2,000 mJ/cm². A UV light source can be adequately selected from a group consisting of a low-pressure mercury-vapor lamps, a high-pressure mercury-vapor lamps, a xenon lamps, a super high-pressure mercury-vapor lamps, a fusion ultraviolet lamps, and so on.

(iii) Crosslinking

The layer of the copolymer may be crosslinked if desired. Examples of crosslinking method include irradiating ionizing radiation, use of a crosslinking agent, and vulcanization. α-ray, a β-ray (electron ray), a γ-ray, and so on can be utilized as the ionizing radiation. An example of the crosslinking agent is a compound having two or more unsaturated bonds, such as butadiene, isoprene, etc. The crosslinking agent is added to the solution including both monomers before polymerization if the method of coating copolymer is performed. The crosslinking agent is added to the monomer/oligomer solution if the method of polymerization is carried out.

### (c) Producing Layer of Organic Silicone Polymer Including Fluorocarbon Group

A layer of a polymer obtained by hydrolyzing a silane compound including fluorocarbon can be formed by applying the application liquid containing the silane compound including fluorocarbon and water, and then using the sol-gel method. In the application liquid, a solvent may be used. Among solvents which may be used are: ethyl alcohol, ethyl alcohol, propyl alcohol, butyl alcohol, methyl cellosolve, and ethyl cellosolve, etc. A catalyst may be added to the application liquid in order to accelerate the hydrolysis of the alkoxy group or in order to accelerate dehydration condensation. Examples of the catalyst include nitric acid, hydrochloric acid, sulfuric acid, phosphoric acid, acetic acid, and ammonia. The method for applying the application liquid may be similar to that described above. The condition for drying the applied layer of application liquid is not limited. However, the optical element which has the applied layer is dried at temperature between room temperature and 400 degrees Celsius for 5 minutes to 24 hours.

### (d) Producing Layer of Fluorocarbon Polymer

A layer of a fluorocarbon polymer can be formed using the vacuum deposition method or a wet method such as a coating method. A method for producing a layer of a fluorocarbon polymer using a coating method is explained below. One of two methods may be applied, as described blow.

In the first coating method, a solution including the copolymer or polymer obtained by polymerizing or copolymerizing at least olefin compound including fluorine, is applied to the optical element, and then the applied solution is dried. In the second coating method, at first, a solution including either olefin compound including fluorine or oligomer thereof is applied to the optical element. Next, the applied solution is dried, and after that it is polymerized or copolymerized.

Both the first and second coating methods may be produced by the same method as that for producing the layer of the copolymer of unsaturated ester monomer including fluoroaliphatic group and unsaturated silane monomer, an described above, except for using the olefin compound, the oligomer thereof, or both of them. Therefore, an explanation of the methods is omitted. However, if the olefin compounds including fluorine are thermosetting, it is preferable to heat the solution at 100 to 140 degrees Celsius for about 30 to 60 minutes.

### (2) Anti-Static Layer

When the layer consists of the conductive inorganic compound, the anti-static layer is produced by same method of physical vapor deposition such as the vacuum deposition or the chemical vapor deposition used to produce the deposited layer of the water-oil repellent layer 60, except for the use of the conductive inorganic compound as the deposition material or the source gas. The composite layer of the conductive inorganic fine particle and binder component is produced by a coating method (wet coating method). Next, the method for producing the composite layer of the conductive inorganic fine particle and the binder according to the coating method is explained below.

### (a) Preparing Slurry

An average particle diameter of the conductive inorganic fine particle is preferably about 5 to 80 nm. If the average particle diameter is more than 80 nm, the transparency of the anti-static layer will be too low. On the other hand, it is difficult to produce conductive inorganic fine particle with average diameter less than 5 nm.

The mass ratio of the conductive inorganic fine particle to the binder component is preferably 0.05 to 0.7. If the mass ratio is more than 0.7, it is difficult to uniformly coat the composite layer, and the formed composite layer will be too fragile. If the mass ratio is less than 0.05 the conductivity of the anti-static layer will be lowered.

Metal alkoxide, an oligomer of the metal alkoxide, an ultraviolet curable compound, or a thermosetting compound are preferable examples of the binder component. When the metal alkoxide, the oligomer, or an ultraviolet curable compound is utilized, the anti-static layer including the binder can be formed even when the optical element is not highly heat resistant.

Examples of the metal alkoxide include silane alkoxide such as methyl tri-alkoxy silane, tetra-alkoxy silane, etc.; zirconium alkoxide such as zirconium tetra-methoxide, zirconium tetra-ethoxide etc.; the titanium alkoxide such as tetramethoxy titanium, tetraethoxy titanium etc.; aluminum alkoxide such as aluminum trimethoxide, aluminum triethoxide etc.; among which the silane alkoxide is preferable.

Examples of the ultraviolet curable compound or the thermosetting compound include a radical polymerizable compound, a cation polymerizable compound, and an anion polymerizable compound. These compounds can be used together.

Acrylic acid, acrylic ester can be utilized as the radical polymerizable compound. Examples of the acrylic acid or the acrylic ester include (meth)acrylic acid; monofunctional (meth)acrylate such as 2-hydroxyethyl (meth)acrylate, 2-hydroxypropyl (meth)acrylate, etc.; di(meth)acrylate such as pentaerythritol di(meth) acrylate, ethylene glycol di(meth)acrylate, etc.; tri(meth)acrylate such as trimethylol propane tri(meth)acrylate, pentaerythritol tri(meth)acrylate, etc.; multifunctional (meth)acrylate such as pentaerythritol tetra(meth)acrylate, di-pentaerythritol penta(meth)acrylate, etc.; and an oligomer of these.

An epoxy compound is preferable as the cation polymerizable compound. Examples of the epoxy compound include phenyl glycidyl ether, ethylene glycol diglycidyl ether, glycerin diglycidyl ether, vinyl cyclohexene dioxide, 1,2,8,9-diepoxy limonene, 3,4-epoxy cyclohexylymethyl 3′,4′-epoxy cyclohexane carboxylate, and bis(3,4-epoxy cyclohexyl) adipate.

If the metal alkoxide is utilized as the binder component, water and a catalyst is added to the slurry including the inorganic fine particle. Examples of the catalyst include nitric acid, hydrochloric acid, sulfuric acid, phosphoric acid, acetic acid, and ammonia. The molar ratio of the added catalyst with respect to the metal alkoxide is preferably 0.0001 to 1. The molar ratio of the metal alkoxide to the water is preferably 1:0.1-5.

If the radical polymerizable compound or cation polymerizable compound is used as the binder component, a radical polymerization initiator or a cation polymerization initiator is added to the slurry including inorganic fine particles. A compound which generates a radical by receiving UV light is utilized as the radical polymerizable initiator. Examples of the preferable radical polymerization initiator include benzyls, benzophenones, thioxanthones, benzyl dimethyl ketals, α-hydroxyalkyl phenones, hydroxyketones, amino alkylphenones, and acyl phosphine oxides. The quantity or the radical polymerization initiator is about 0.1 to 20 parts by mass with respect to 100 parts by mass of the radical polymerizable compound.

A compound which generates a cation by receiving UV light is utilized as the cation polymerization initiator. Examples of the cation polymerization initiator include an onium salt, such as a diazonium salt, a sulfonium salt, and an iodonium salt. The quantity of the cation polymerization initiator is about 0.1 to 20 parts by mass with respect to 100 parts by mass of the cation polymerizable compound.

The inorganic fine particle and the binder component mixed into the slurry may include more than two kinds of each. In addition, a general additive, such as dispersant, stabilizer, viscosity modifier, a colorant, can be mixed into the slurry as long as the desired properties of the slurry remain.

The concentration of the slurry influences the thickness of the anti-static layer. Examples of the solvent include alcohols such as methanol and ethanol, alkoxy alcohols such as 2-ethoxy ethanol and 2-buthoxy ethanol, ketols such as diacetone alcohol, ketones such as acetone and methyl ethyl ketone, aromatic hydrocarbons such as toluene and xylene, and esters such as ethyl acetate and butyl acetate. The quantity of solvent is about 20-10,000 parts by mass with respect to 100 parts by mass of total of the inorganic fine particle and a binder component.

### (b) Coating

The slurry including the inorganic fine particles is applied to the optical element by the common method described above. After applying the slurry, the binder component in the slurry is polymerized. If the binder component is the metal alkoxide or its oligomer, the binder component is cured at 80 to 400 degrees Celsius for 30 minutes to 10 hours. If the binder component is the ultraviolet curable compound, the binder component is polymerized by irradiating with UV light of about 50 to 3,000 mj/cm² with results in the layer consisting essentially of the conductive inorganic fine particle and the binder. The period of ultraviolet light exposure may depend on the thickness of the layer, but ranges between about 0.1 to 60 seconds.

After that, the solvent of the slurry including a conductive inorganic fine particle is volatilized. In order to volatilize the solvent, the slurry may be kept at room temperature or heated to about 30-100 degrees Celsius.

### (3) Producing Fine Roughness Layer

### (a) Producing Fine Roughness Alumina Layer

At first, a gel layer including alumina is formed by applying an application liquid including aluminum compound, or a deposited layer consisting essentially of aluminum, alumina, or a mixture of these is formed. Next, the fine roughness alumina layer is obtained by treating the gel or deposited layer with hot water.

### (i) Producing Gel Layer Including Alumina

Examples of the aluminum compound include aluminum alkoxide, aluminum nitrate, and aluminum sulfate, but aluminum alkoxide is preferable. A method for producing the fine roughness alumina layer using aluminum alkoxide is disclosed in Japanese Patent No. 3668042 and Japanese Unexamined Patent Publication Nos. H9-202649 and H9-202651. According to the method in No. 3688042, No. H9-202649, and No. H9-202651, at first, an application liquid including aluminum alkoxide, water, and stabilizer is applied to the optical element, and then the alumina gel layer is formed from the applied liquid on the optical element by the sol-gel method. Next, the fine roughness alumina layer is obtained by treating the alumina gel layer with hot water.

Next, the method for producing the fine roughness alumina layer using the aluminum alkoxide will be explained in detail. Examples of the aluminum alkoxide include aluminum trimethoxide, aluminum triethoxide, aluminum triisopropoxide, aluminum tri-(n-butoxide), aluminum tri-(sec-butoxide), aluminum tri-(tert-butoxide), aluminum acetyl acetate, and oligomer obtained by partially hydrolyzing one or more than one of these.

If the fine roughness alumina layer includes the above optional component, the optional component material, which is at least one selected form the group consisting of zirconium alkoxide, silane alkoxide, titanium alkoxide, and zinc compound, is added to the application liquid.

Examples of the zirconium alkoxide include zirconium tetra-methoxide zirconium tetra-ethoxide, zirconium tetra-(n-propoxide), zirconium tetraisopropoxide, zirconium tetra-(n-butoxide), zirconium tetra-(t-butoxide), etc.

The silane alkoxide is represented by the following formula:

Si(OR⁶)ₓ(R⁷)₄₋ₓ (11)

In Formula 11, R⁶ is preferably an alkyl group having 1 to 5 carbon atoms, or an acyl group having 1 to 4 carbon atoms such as methyl group, ethyl group, n-propyl group, i-propyl group, n-butyl group, sec-butyl group, tert-butyl group, acetyl group, etc. R⁷ is preferably an organic group having 1 to 10 carbon atoms, for example: a non-substituted hydrocarbon group such as methyl group, ethyl group, n-propyl group, i-propyl group, n-butyl group, tert-butyl group, n-hexyl group, cyclohexyl group, n-octyl group, tert-octyl group, n-decyl group, phenyl group, vinyl group, allyl group, etc.; and a substituted hydrocarbon group such as γ-chloropropyl group, CF₃CH₂— group, CF₃CH₂CH₂— group, C₂F₅CH₂CH₂— group, C₃F₇CH₂CH₂CH₂— group, CF₃OCH₂CH₂CH₂— group, C₂F₅OCH₂CH₂CH₂— group, C₃F₇OCH₂Cl₂CH₂— group, (CF₃)₂CHOCH₂CH₂CH₂— group, C₄F₉CH₂OCH₂CH₂CH₂— group, 3-(perfluoro cyclo hexyloxy) propyl group, H(CF₂)₄CH₂OCH₂CH₂CH₂— group, H(CF₂)₄CH₂CH₂CH₂— group, γ-glycidoxypropyl group, γ-mercaptopropyl group, 3,4-epoxycyclohexylethyl group, γ-methacryloyloxypropyl group etc. X is an integer ranging 2 to 4.

Examples of the titanium alkoxide include tetramethoxy titanium, tetraethoxy titanium, tetra-(n-propoxy) titanium, tetra-isopropoxy titanium, tetra-(n-propoxy) titanium, tetra-(n-butoxy) titanium, tetra-isobutoxy titanium, etc.

Examples of the zinc compound include zinc acetate, zinc chloride, zinc nitrate, zinc stearate, zinc oleate, and zinc salicylate, etc., and zinc acetate and zinc chloride being preferred.

The quantity of the optional component material is preferably 0.01 to 50 mass percents, and is more preferably 0.05 to 30 mass percents with respect to 100 mass percents of total quantity of the aluminum alkoxide and the optional component material.

The stabilizer is preferably added to the application liquid. As the stabilizer, there are β-diketones such as acetylacetone, ethyl acetoacetate, etc.; alkanol amines such as monoethanol amine, diethanol amine, triethanol amine, etc.; and metal alkoxides, etc.

The application liquid may include a solvent, such as methyl alcohol, ethyl alcohol, propyl alcohol, butyl alcohol, methyl cellosolve, ethyl cellosolve, etc.

The molar ratio of the metal alkoxide, the solvent, the stabilizer, and the water ((aluminum alkoxide+optional component material):solvant:stabilizer:water) is preferably 1:10-100:0.5-2:0.1-5.

A catalyst may be added to the application liquid in order to accelerate the hydrolysis of the alkoxy group or in order to accelerate dehydration condensation Examples of the catalyst include nitric acid, hydrochloric acid, sulfuric acid, phosphoric acid, acetic acid, and ammonia. The molar ratio of the added catalyst with respect to the metal alkoxide is preferably 0.0001 to 1.

Organic water-soluble polymer may be added to the application liquid, if desired. When the alumina gel layer which is formed from the application liquid including the organic water-soluble polymer is treated with hot water, the organic water-soluble polymer is dissolved from the alumina gel layer so that the reaction surface area between the alumina gel layer and the hot water is increased. Therefore, it is possible to produce the fine roughness alumina layer in a short period and at relatively low temperature. The shape of the roughness of the fine roughness alumina layer is controlled by selecting the kind and a molecular weight of the added organic water-soluble polymer.

Examples of the organic water-soluble polymer include polyvinyl pyrrolidone, polyvinyl alcohol, polymethyl vinylether, polyethylene glycol, and, polypropylene glycol. The quantity of the organic water-soluble polymer may be 0.01 to 10 mass percents, with respect to 100 mace percents of alumina assuming that all aluminum alkoxide is changed to the alumina.

As the method of applying the application liquid, any common coating method described above can be utilized. For example, the thickness of the layer can be controlled by changing a speed of withdrawal in the dip coating method, the rotational speed of the optical element in the spin coating method, or the concentration of the application liquid. In the dip coating methods it is preferable that the speed of withdrawal be about 0.1 to 3.0 mm/second.

The conditions for drying the applied layer of the application liquid are not limited, but depend on the heat resistance of the optical element. Generally, the optical element with an applied layer is dried at between room temperature and 400 degrees Celsius for 5 minutes to 24 hours.

### (ii) Method for Producing Deposited Layer

The deposited layer consisting essentially of aluminum, alumina, or the mixture of these is formed on the optical element using physical vapor deposition, such as vacuum deposition etc., or chemical vapor deposition (CVD), but the vacuum deposition is preferable. It is preferable that the thickness of the deposited layer be 5 to 500 nm in order to form the uniform deposited layer and to form the fine roughness layer 62 of with a three-dimensional average surface roughness SRa in a preferable range.

An aluminum deposited layer is formed by using aluminum as the deposition material. The deposition speed and a temperature of the optical element during deposition process are not limited, hut are preferably 1 to 10 nm/second and 20 to 80 degrees Celsius, respectively, in order to form a uniform aluminum deposited layer

An alumina deposited layer is formed according to a first or second method. In the first method, alumina is used as the deposition material. In the second method, aluminum is used as the deposition material and a reactive deposition is carried out while a little oxygen is blown into the vacuum deposition apparatus. In the first method, in order to form a uniform alumina deposited layer, the deposition speed and temperature of the optical element during deposition process are not limited but are preferably from 0.1 to 1.0 nm/minute, and 20 to 300 degrees Celsius, respectively. In the second method, the oxygen blown so that the pressure in the vacuum deposition apparatus is maintained between 1×10⁻⁴ and 1×10⁻² Pa.

Among the various CVDS, the plasma CVD, where a thin layer can be formed at low temperature, is preferable. In the plasma CVD, an aluminum deposited layer is formed by generating plasma of a source gas and then carrying out a chemical reaction, such as decomposition, reduction, oxidation, substitution, and so on, at the surface of the optical element. Examples of the source gas include aluminum halide such as AlCl₃, organic aluminum such as Al(CH₃)₃, Al(i-C₄H₉)₃, (CH₃)₂AlH, etc., organic aluminum complex, aluminum alcoholate, and so on. The source gas is sent to the surface of the optical element with substitute gas, such a helium, argon, and so on. Reactive gas, such as hydrogen, nitrogen, ammonia, nitrous oxide, oxide, carbon monoxide, methane, and so on, may be mixed with the source gas.

(iii) Hot Water Treatment

The gel layer or the deposited layer is treated with hot water (or mixture of water and an organic solvent), having temperature between 40 and 100 degrees Celsius. For example, the optical element having the gel layer or deposited layer is preferably immersed in the hot water or the mixture. In this case, the temperature of the hot water or the mixture is preferably 50 to 100 degrees Celsius. Furthermore, the immersion period is preferably 1 to 240 minutes.

A base may be added to the water which is used in the hot water treatment if desired. The fine roughness layer will be formed quickly owing to the adding base. An inorganic or organic base can be used as the base. Amine can serve as the organic base. Examples of the preferable amine include alcoholamine such as monoethanelamine, diethanolamine, triethanolamine, etc., and alkylamine such as methylamine, dimethylamine, trimethylamine, n-buthylamine, n-propylamine, etc. Examples of the inorganic base include ammonia, sodium hydroxide, and potassium hydroxide. The quantity of the base is not limited, but is preferably 0.1 to 1 mass percent with respect to the 100 mass percents of the total of water and base.

In case of the mixture of water and the organic solvent, alcohol, such as methanol, ethanol, propylalcohol, buthylalcohol, and so on, is preferable for the organic solvent. The quantity of the organic solvent is not limited as long as the benefits of this embodiment are not lost.

By treating the gel or deposited layer with hot water, the roughness comprising a plurality of convexities having an irregular fine shape and an interspersed plurality of concavities having grooved shape, are formed on the superficial layer of the gel or deposited layer. The reason such roughness is formed is unclear. However, it is hypothesized that at least the superficial layer of the deposited layer is changed to aluminum hydroxide, such as boehmite, by the hot water, and then the aluminum hydroxide is dissolved out and precipitates instantly.

### (iv) Drying Process

The optical element is preferably dried at from room temperature to 500 degrees Celsius after producing the roughness on the surface of the gel or deposited layer. The optical element is more preferably burned at 100 to 450 degrees Celsius. The drying or burning period is preferably 10 minutes to 36 hours. Drying results in a fine roughness layer 62 with roughness, whose main component is alumina, aluminum hydroxide or a mixture of thereof. Furthermore, even if the aluminum deposited layer is treated with hot water, the fine roughness layer 62 whose main component is alumina, aluminum hydroxide or a mixture of thereof is usually obtained.

### (b) Producing Fine Roughness Zinc Compound Layer

At first, the gel layer is formed by applying an application liquid (solution or dispersion liquid) including zinc compound on the optical element and drying it. Next, the fine roughness zinc compound layer is obtained by treating the gel layer with water having a temperature greater than or equal to 20 degrees Celsius.

Examples of zinc compound include zinc acetate, zinc chloride, zinc nitrate, zinc stearate, zinc oleate, and zinc salicylate, etc., and zinc acetate or zinc chloride is preferred. If the fine roughness zinc compound layer includes the optional component, at least one optional component material which is selected from the group consisting of aluminum alkoxide, zirconium alkoxide, silane alkoxide, and titanium alkoxide may be added to the application liquid.

The examples of aluminum alkoxide, the zirconium alkoxide, the silane alkoxide, and titanium alkoxide are the same as those mentioned above. The quantity of the optional component material is preferably between 0.01 and 50 mass percents, and more preferably 0.05 to 30 mass percents, with respect to 100 mass percents of total quantity of the zinc compound and the optional component material.

The solvent or the application liquid and the method for applying the application liquid when the fine roughness zinc compound layer is produced may be the same as those used to produce the fine roughness alumina layer. The molar ratio in the application liquid is preferably (zinc compound+optional component material); solvent=1:10-20. The stabilizer and catalyst described above, and water may be added to the application liquid, if desired. The application liquid which has been applied to the optional element is dried at room temperature for about 30 minutes, but may be dried by heat if desired.

The dried gel layer is treated with water whose temperature greeter then or equal to 20 degrees Celsius. Due to this treatment, the superficial layer of the gel is deflocculated and then the structure thereof is rearranged so that zinc oxide and/or zinc hydroxide, or their hydrate are precipitated and then the precipitation grows on the superficial layer. In this treatment, the temperature of the water is preferably 20 to 100 degrees Celsius. The treatment period is preferably 5 minutes to 24 hours. The fine roughness zinc compound layer which is produced as described above is usually colorless and of high transparency.

### (c) Producing by Photolithographic Method

The metal oxide layer consisting essentially of a transparent metal oxide such as alumina, zinc oxide, zirconia, silica, titania, etc., is patterned by the photolithographic method. The metal oxide layer may be obtained by a wet coat process such as the sol-gel method or by the deposition method, as described above.

In this method, at first, a photoresist is applied on the metal oxide layer, and a mask is applied thereon, and then the photoresist is exposed. Next, the exposed part or the non-exposed part of the photoresist is removed by a developing process so that the resist pattern is formed and then the metal oxide layer is etched. The mask has a fine pattern so that the SRa of the layer after etching is in the range as described above. The shape of the pattern is not limited.

Anisotropic etching is preferable as the etching method. Examples of anisotropic etching include fast atom beam (FAB) etching, reacting ion etching (RIE), reactive ion beam etching (RIBE), etc. Among these, FAB and RIE are preferable because of their high anisotropy, with FAB the more preferable. The fast atom beam is a neutral energy particle beam, and the directional quality thereof is high because electric charge does not accumulate and ions are prevented from repelling each other. Therefore, when dry etching is carried out by the FAB, the fine roughness can be formed accurately.

### (4) Other Treatment

Before producing each of the water-oil repellent layer 60, the anti-static layer 61, and the fine roughness layer 62, a corona discharge treatment or a plasma treatment may be carried out on the optical element or the layer underlying the above-mentioned layer to be formed in order to remove adsorbed water and impurities and to activate the surface. Such treatments increase the adhesiveness between the layers or between the layer and the optical element.

As described above, in the finder optical system according to the above embodiments, the liquid bridge force between a dust particle and an optical element can be reduced by the water-oil repellent layer, and the electrostatic attractive force and the electric image force between the dust particle and the optical element can be reduced by the anti-static layer. Therefore, the dust-proofing ability of the optical element can be improved.

In particular, when the fine roughness layer is provided on the optical element, the intermolecular force and the contact-charging adhesion force of the dust adhering to the optical element can be reduced, which can further improve the dust-proofing ability. Therefore, it is not necessary to provide a dust-proofing mechanism which mechanically removes the dust for the optical element. Hence, the cost, the weight, and the power consumption in the single-lens reflex camera can be reduced.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2007-177668 (filed on Jul. 5, 2007) which is expressly incorporated herein, by reference, in its entirety.

1. A finder optical system comprising:
a reflex mirror that is disposed on an optical path of a photographing optical system;
a focal plane plate that is disposed at a position on which an image is formed by a light which passes said photographing optical system and which is reflected by said reflex mirror;
a prism whose light-input surface faces a light-output surface of said focal plane plate;
an eyepiece that faces a light-output surface of said prism; and
a dust-proofing multilayer that is provided on a surface of said focal plane plate, said dust-proofing multilayer comprising a water-repellent or water- and oil-repellent layer and an anti-static layer.

2. A finder optical system according to claim 1, wherein a dust-proofing multilayer is provided on a surface of at least one of said prism and said eyepiece.

3. A finder optical system according to claim 1, wherein said dust-proofing multilayer further comprises a fine roughness layer with fine roughness formed at its surface.

4. A finder optical system according to claim 3, wherein said water-repellent or water- and oil-repellent layer in disposed at an outermost surface of said dust-proofing multilayer,
said fine roughness layer disposed between said water-repellent or water- and oil-repellent layer and said anti-static layer or an underlying said anti-static layer.

5. A finder optical system according to claim 3, wherein said fine roughness layer includes at least one selected from the group consisting of alumina, aluminum hydroxide, zinc oxide, and zinc hydroxide.

6. A finder optical system according to claim 3, wherein said fine roughness comprises a plurality of convexities having a fine shape and a plurality of concavities having grooved shape, said plurality of convexities irregularly distributed and said concavities located between said convexities.

7. A finder optical system according to claim 3, wherein the three-dimensional average surface roughness of an outermost surface of said dust-proofing multilayer is between 1 and 100 nm.

8. A finder optical system according to claim 3, wherein the maximum peak-to-valley value of roughness at an outermost surface of said dust-proofing multilayer is between 5 and 1,000 nm.

9. A finder optical system according to claim 3, wherein the specific surface area of an outermost surface of dust-proofing multilayer is greater than or equal to 1.05.

10. A finder optical system according to claim 1, wherein said system comprises a dust-proofing mechanism that mechanically removes dust adhering to a surface of said focal plane plate.

11. A finder optical system according to claim 10, wherein said dust-proofing mechanism vibrates said focal plane plate or wipes a surface of said focal plane plate off.

12. A finder optical system according to claim 11, wherein said dust-proofing mechanism comprises a piezoelectric element that vibrates said focal plane plate.

13. A finder optical system according to claim 11, wherein said dust-proofing mechanism comprises a roller that is rolled on said surface of said focal plane plate while contacting said surface of said focal plane plate.

14. A finder optical system according to claim 11, wherein said dust-proofing mechanism comprises a wiper that is moved across said surface of said focal plane plate while contacting said surface of said focal plane plate.

15. A finder optical system according to claim 1, wherein said reflex mirror is disposed rotatably, and an airflow that is generated by rotating said reflex mirror passes a space between said focal plane plate and said prism, so as to remove dust adhering to at least one of light-output surface of said focal plane plate and a light input-surface of said prism.

16. A finder optical system according to claim 15, wherein said reflex mirror is flipped up by rotating, said airflow being generated by said reflex mirror that is flipped up.

17. A finder optical system according to claim 15, wherein said reflex mirror that is flipped up contacts a cushioning medium so as to stop at a position close to said focal plane plate and so as to substantially face said focal plane plate.

18. A finder optical system according to claim 1, wherein said reflex mirror and said focal plane plate are disposed in a mirror box that is fixed to a camera, an adhesive material disposed in said mirror box, dust adhering to said adhesive material.

19. A single-lens reflex camera comprising a finder optical system and a photographing optical system, said finder optical system comprising:
a reflex mirror that is disposed on an optical path of said photographing optical system;
a focal plane plate that is disposed at a position on which a image is formed by a light which passes said photographing optical system and which in reflected by said reflex mirror;
a prism whose light-input surface faces a light-output surface of said focal plane plate;
an eyepiece that faces a light-output surface of said prism; and
a dust-proofing multilayer that is provided on a surface of said focal plane plate, said dust-proofing multilayer comprising a water-repellent or water- and oil-repellent layer and an anti-static layer.
